(19) United States
(12) Patent Application Publication
(10) Pub. No.: US 2014/0010043 A1
(43) Pub. Date: Jan. 9, 2014

(54) Portable Sonar Imaging System and Method

(71) Applicants: Stanley Jerome Pawlik, St. Paul, MN (US); Matthew Ryan Berberich, Stillwater, MN (US)

(72) Inventors: Stanley Jerome Pawlik, St. Paul, MN (US); Matthew Ryan Berberich, Stillwater, MN (US)

(21) Appl. No.: 13/935,459

(22) Filed: Jul. 3, 2013

Related U.S. Application Data
(60) Provisional application No. 61/667,948, filed on Jul. 4, 2012.

(51) Int. Cl. G01S 15/96; G06F 17/30; G01S 15/89

(52) U.S. Cl. CPC G01S 15/96; G01S 15/89; G06F 17/30289; G06F 17/30424; G06F 17/30554
USPC 367/7; 367/99; 707/609; 707/769; 707/722

(57) ABSTRACT

A portable sonar imaging system includes a portable electronic device, a sonic transducer, and a portable sonar data preprocessing device. The portable sonar data preprocessing device includes a transducer adapter for connecting to a sonic transducer and further includes a portable sonar data preprocessing device interface for communicating with the portable electronic device. The portable sonar data preprocessing device receives analog sonar data from the sonic transducer, converts the analog sonar data to digital sonar data, and provides the digital sonar data to a portable electronic device interface of the portable electronic device through the portable sonar data preprocessing device interface. In turn, the portable electronic device generates a graphical image based on the digital sonar data and displays the graphical image on a display screen of the portable electronic device. In further embodiments, a historical fish locator system including the portable sonar imaging system generates a fish event database.

### CROSS-REFERENCE TO RELATED APPLICATIONS

This application claims benefit of U.S. Provision Patent Application Ser. No. 61/667,948, filed Jul. 4, 2012, entitled “Portable Sonar Imaging System and Method,” which application is incorporated by reference herein in its entirely.

### BACKGROUND

A fish locator device is often used to identify the location of fish in a body of water. One type of fish locator device is mounted to a fishing vessel and powered directly by a main power supply of the fishing vessel. In this way, the fish locator device becomes a permanent fixture on the fishing vessel. Another type of fish locator device is powered by a portable power source and includes a sonic transducer component connected to a processing and display component. The sonic transducer component generates sonic waves in a body of water and receives reflected sonic waves in response to the generated sonic waves. The processing and display component generates and displays a sonar image, based on the transmitted and reflected sonic waves, indicating the location of fish and other objects below the sonic transducer component within the body of water. Because this type of fish locator device is not permanently mounted to a vessel, it is often used for ice fishing activities. Typically, this type of fish locator device comes in an all-in-one packaged product including a processor, a large portable power source, a digital display screen, and a transducer component. Because the cost of the all-in-one packaged product is expensive, many persons do not use such a fish locator device for ice fishing activities.

### SUMMARY

In various embodiments, a sonar data preprocessing device includes a transducer adapter for connecting to a sonic transducer and for receiving analog sonar data from the sonic transducer. The sonar data preprocessing device further includes an analog-to-digital converter for converting the analog sonar data to digital sonar data. Additionally, the sonar data preprocessing device includes a digital data interface for providing the digital sonar data to a portable electronic device interface of a portable electronic device. In further embodiments, the portable electronic device generates a graphical image based on the digital sonar data and displays the graphical image on a display screen of the portable electronic device. Because the sonar data preprocessing device provides digital sonar data to the portable electronic device through the portable electronic device interface of the portable electronic device, a dedicated processing and display component is not needed for generating the graphical image.

An advantage of the sonar data preprocessing device is that a portable sonar imaging system can be constructed by connecting the sonar data preprocessing device to a sonic transducer and to a portable electronic device that has a separate and distinct function from a fishing activity, for example a mobile phone for receiving and making phone calls. As a result, cost of the portable sonar imaging system is reduced in comparison to fish locator devices that require a dedicated processing and display component. Furthermore, because such a portable electronic device is typically carried on a person during a fishing activity, the weight of the portable sonar imaging system is reduced in comparison to fish locator devices that require a dedicated processing and display component. As a result, the portable sonar imaging system can be used to locate fish and lake depths quickly and easily without the need for carrying around a heavy piece of equipment. In particular, the portable sonar imaging system is beneficial to a fisherman that is trying to determine a location to place or move an ice fishing house based on fish location or lake depth.

One aspect of the present invention is to share the expense of a display technology of a fish locator device with that of a portable and wireless device (i.e. “smart” phone or other similar device). Instead of requiring a large, heavy and bulky all-in-one fish locator product, the use of a sonic transducer coupled with that of a sonar data preprocessing device communicates with a multi-functional portable wireless device for display purposes. In this way, the portable sonar imaging system provides a smaller and more compact portable product option with the added bonus of using a user's existing portable wireless device display to save on cost. Due to the portable sonic imaging system's compact nature and ease of portability, a person wishing to engage in an ice fishing activity could easily travel longer distances to identify lake depths and the presence of fish in any particular location on a lake. The portable sonic imaging system is particularly useful in ice fishing situations in which moving or finding optimal fishing locations is arduous. The fish locating function describe above is not the only use for the portable sonic imaging system. Several other functions and uses of the portable sonic imaging system exist and are described further in this patent application.

In various embodiments, the portable sonar imaging system functions as a fish locator device that may be easily moved to various locations during a fishing activity. For example, the portable sonar imaging system may be easily moved to different locations on a fishing vessel along with a portable electronic device or may be connected to different portable electronic devices on the fishing vessel without requiring disconnection and reconnection to a main power supply of the fishing vessel. The portable sonar imaging system may also be passed from one fishing vessel to another fishing vessel for use with a portable electronic device and a sonic transducer of each respective fishing vessel without requiring disconnection and reconnection to a main power supply of either fishing vessel. Similarly, the portable sonar imaging system may be easily moved to different locations during an ice fishing activity. For example, the portable sonar imaging system may be moved to an ice fishing hole on a lake to locate fish beneath the ice fishing hole before transporting an ice fishing house to the ice fishing hole.

A sonar data preprocessing device, in accordance with one embodiment, includes a transducer adapter, a computing processor, and a portable sonar data preprocessing device interface. The computing processor is coupled to the transducer adapter and the portable sonar data preprocessing device interface. The transducer adapter is configured to provide control signals to the sonic transducer for generating sonic pulses, receive reflected sonic pulses from the sonic transducer in response to providing the control signals to the sonic transducer, and generate analog sonar data based on the reflected sonic pulses. The computing processor is configured to generate digital sonar data based on the analog sonar data. The portable sonar data preprocessing device interface is configured to provide the digital sonar data to a portable electronic device for generating a graphical image based on the digital sonar data.

A method of generating a sonar image, in accordance with one embodiment, includes generating sonic pulses, receiving reflected sonic pulses, generating analog sonar data based on the reflected sonic pulses and generating digital sonar data based on the analog sonar data. The method further includes transmitting the digital sonar data to a portable electronic device, generating a graphical image based on the digital sonar data, and displaying the graphical image on the portable electronic device.

A historical fish locator system, in accordance with one embodiment, includes a portable sonar imaging system, a fish event data repository, and a fish event data server. The portable sonar imaging system is configured to generate fish event data. The fish event data repository is configured to store the fish event data in a fish event database. The fish event data server is configured to update the fish event database based on the fish event data.

A method of generating fish event data for a fish event data repository, in accordance with one embodiment, includes receiving digital sonar data, receiving geographical location data, and generating fish location data based on the digital sonar data and the geographical location data. The method also includes generating a time stamp, generating environmental condition data, and generating fish event data based on the fish location data, the time stamp, and the environmental condition data. Additionally, the method further includes transmitting the fish event data to a fish event data repository.

A method of updating a fish event database, in accordance with one embodiment, includes receiving fish event data from a fish event repository and updating a fish event database based on the fish event data.

A method of querying a fish event database, in accordance with one embodiment, includes receiving a fish event data query, retrieving fish event data from a fish event database based on the fish event data query, and providing the fish event data in response to the fish event data query.

A method of displaying fish event data, in accordance with one embodiment, includes generating a fish event data query and receiving fish event data in response to the fish event data query. The method further includes generating a graphical image based on the fish event data and displaying the graphical image.

### BRIEF DESCRIPTION OF THE DRAWINGS

The accompanying drawings are included to provide a further understanding of the invention, and are incorporated in and constitute a part of this specification. The drawings illustrate embodiments of the invention, and together with the description, serve to explain the principles of the invention.

FIG. 1 is a block diagram of a portable sonar imaging system, in accordance with an embodiment of the present invention.

FIG. 2 is a flow chart of a method of generating a sonar image, in accordance with an embodiment of the present invention.

FIG. 3 is a block diagram of a historical fish locator system, in accordance with an embodiment of the present invention.

FIG. 4 is a block diagram of a historical fish locator system, in accordance with an embodiment of the present invention.

FIG. 5 is a flow chart of a method of generating fish event data for a fish event data repository, in accordance with an embodiment of the present invention.

FIG. 6 is a flow chart of a method of updating a fish event database, in accordance with an embodiment of the present invention.

FIG. 7 is a flow chart of a method of querying a fish event database, in accordance with an embodiment of the present invention.

FIG. 8 is a flow chart of a method of displaying fish event data on a portable electronic device, in accordance with an embodiment of the present invention.

### DETAILED DESCRIPTION

In various embodiments, a portable sonar data preprocessing device receives analog sonar data from an sonic transducer, converts the analog sonar data to digital sonar data, and provides the digital sonar data to a portable electronic device interface of a portable electronic device. In turn, the portable electronic device generates a graphical image based on the digital sonar data and displays the graphical image on a display screen of the portable electronic device. Because the portable sonar data preprocessing device provides digital sonar data to the portable electronic device through the portable electronic device interface of the portable electronic device, a dedicated computer and display device are not needed for generating the graphical image.

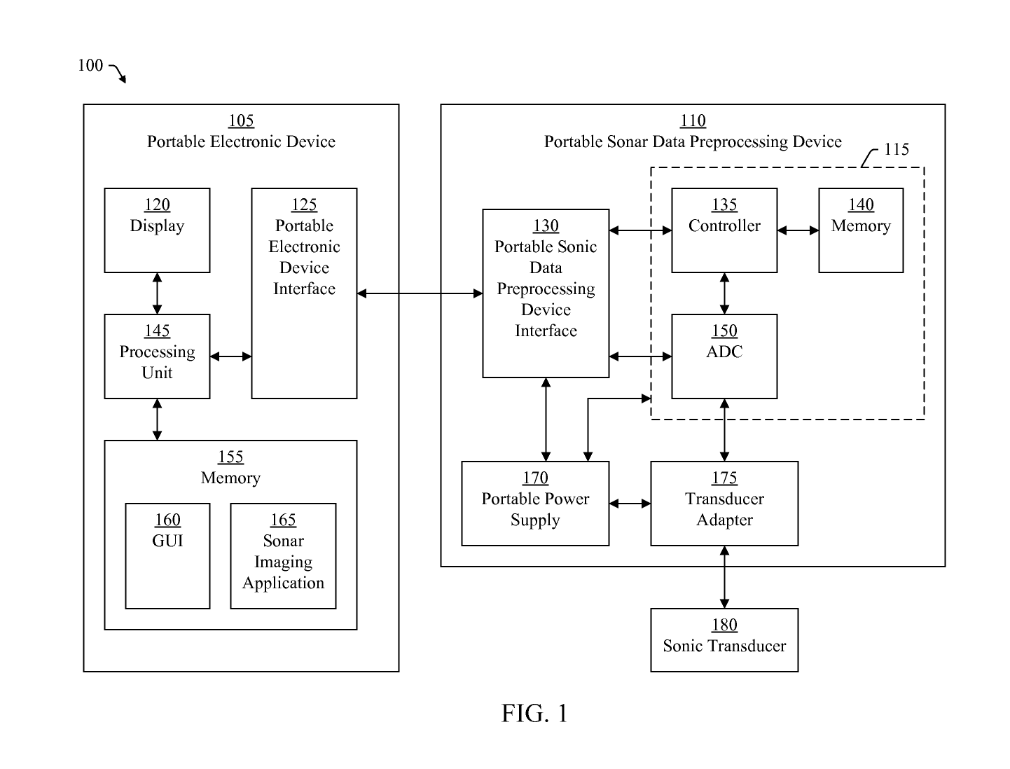

FIG. 1 illustrates a portable sonar imaging system 100, in accordance with an embodiment of the present invention. The portable sonar imaging system 100 includes a portable electronic device 105, a portable sonar data preprocessing device 110, and a sonic transducer 180. The portable sonar data preprocessing device 110 is coupled to both the portable electronic device 105 and the sonic transducer 180. In various embodiments, the sonic data preprocessing device 110 is electrically and mechanically coupled to the portable electronic device 105 or the sonic transducer 180, or both. In some embodiments, the portable sonar data preprocessing device 110 is coupled to the portable electronic device 105 via a wireless communication link.

The portable electronic device 105 may be any portable communication or computing device that includes a visual display screen and is capable of being powered by a portable power supply. For example, the portable electronic device 105 may be a mobile phone, a laptop computer, a tablet computer, an electronic book reader, or the like. The sonic transducer 180 may be any system or device for generating analog sonar data. In various embodiments, the sonic transducer 180 generates sonic pulses, receives reflected sonic pulses in response to the generated sonic pulses being reflected from the surface of an object, and generates analog sonar data based on the reflected sonic pulses. For example, the sonic transducer 180 may be mounted to the hull of a fishing vessel for generating sonic pulses below a waterline of the fishing vessel and for generating analog sonar data based on reflected sonic pulses received at the sonic transducer 180 in response to the generated sonic pulses. Accordingly, one application of the portable sonar imaging system 100 is for detecting objects, such as fish, located below the waterline of the fishing vessel and for displaying locations of the objects on the visual display of the portable electronic device 105. In this way, the portable sonar imaging system 100 functions as a fish locator device.

In various embodiments, the portable sonar data preprocessing device 110 includes a computing processor 115, a portable sonar data preprocessing device interface 130, a transducer adapter 175, and a portable power supply 170 electrically coupled to the computing processor 115, the portable sonar data preprocessing device interface 130, and the transducer adapter 175. The computing processor 115 may be any system or device for generating digital data based on analog data. For example, the computing processor 115 may be a microprocessor, a microcontroller, an embedded processor, a central processing unit, a digital signal processor, or the like. The portable sonar data preprocessing device interface 130 may be any system or device for providing digital sonar data from the sonar data processing device 110 to the portable electronic device 105. For example, the portable sonar data preprocessing device interface 130 may be a universal serial bus (USB) interface, such as USB 1.0, USB 2.0, or USB 3.0.

The transducer adapter 175 may be any system or device for receiving analog sonar data from the sonic transducer 180 and providing the analog sonar data to the computing processor 115. In some embodiments, the transducer adapter 175 provides control signals to the sonic transducer 180 for causing the sonic transducer 180 to generate sonic pulses. In turn, the sonic transducer 180 generates sonic pulses, received reflected sonic pulses in response to the generated sonic pulses, and generates analog sonar data based on the reflected sonic pulses. In this way, the transducer adapter 175 controls operation of the sonic transducer 180.

The portable power supply 170 may be any self-contained power supply for providing electrical power to the portable sonar data preprocessing device 110 that does not require a continuous connection to a fixed power source, such as an AC outlet. In various embodiments, the portable power supply 170 is a battery, a fuel cell, a solar cell, or the like. For example, the portable power supply 170 may be a 9-volt battery. Because the portable sonar data preprocessing device 110 includes a portable power supply 170, the portable sonar data preprocessing device 110 has applications in which a fixed power source is not available. For example, the portable sonar data preprocessing device 110 may be used to locate fish beneath the surface of ice on a lake when engaging in an ice fishing activity.

In various embodiments, the computing processor 115 includes a controller 135, a memory 140, and an analog-to-digital converter (ADC) 150. The controller 135 is electrically coupled to the memory 140, the analog-to-digital converter 150, and the portable sonar data preprocessing device interface 130. In some embodiments, the portable sonar data preprocessing device interface 130 is part of the computing processor 115. In some embodiments, the memory 140 or the analog-to-digital converter 150, or both, are external to the computing processor 115. In various embodiments, the controller 135 controls operation of the memory 140, the analog-to-digital converter 150, or the portable sonar data preprocessing device interface 130, or some combination thereof.

The portable electronic device 105 includes a display 120, a portable electronic device interface 125, a processing unit 145, and a memory 155. The processing unit 145 is electrically coupled to the display 120, the portable electronic device interface 125, and the memory 155. The portable electronic device interface 125 may be any system or device for communicating data with a system or device external to the portable electronic device 105. For example, the portable electronic device interface 125 may be a universal serial bus (USB) interface, such as USB 1.0, USB 2.0, or USB 3.0. The display 120 may be any type of device for displaying a graphical image. The memory 155 may be any type of memory for storing data. For example, the memory 155 may be a random access memory (RAM), a flash storage, a hard disk drive, or the like.

In various embodiments, the portable electronic device interface 125 receives digital sonar data generated by the portable sonar data preprocessing device 110 through the portable sonar data preprocessing device interface 130 and provides the digital sonar data to the processing unit 145. In turn, the processing unit 145 writes the digital sonar data into the memory 155. In some embodiments, the portable sonar data preprocessing device interface 130 writes the digital sonar data into the memory 155. In turn, the memory 155 stores the digital sonar data. In some embodiments, the processing unit 145 includes the memory 155 or a portion of the memory 155.

As illustrated in FIG. 1, the memory 155 stores a graphical user interface (GUI) 160 and a sonar imaging application 165. In operation, the processing unit 145 executes the sonar imaging application 165 to generate a graphical image based on the digital sonar data received by the portable electronic device interface 125. Additionally, the processing unit 145 executes the graphical user interface 160 to display the graphical image on the display 120. For example, the sonar imaging application 165 may be a fish locator application for generating the graphical image based on the digital sonar data such that the graphical image indicates the location of fish below the water surface of a lake. In various embodiments, the graphical user interface 160 is part of an operating system executed by the processing unit 145, for example a Microsoft Windows or Android operating system. In some embodiments, the processing unit 145 receives user data input through the graphical user interface 160 for modifying the graphical image displayed on the display 120.

In one embodiment, the sonar imaging application 165 has two distinct and separate display modes. In a first display mode, the graphical image generated by executing the sonar imaging application 165 includes the depth of a body of water at the location in which the sonic transducer 180 is submerged below the surface of the body of water. In a second display mode, the graphical image generated by executing the sonar imaging application 165 includes any objects between the surface of the body of water and the bottom of the body of water. In this way, the sonar imaging application 165 detects fish below the surface of the body of water based on the digital sonar data and the second display mode functions as a fish locator device.

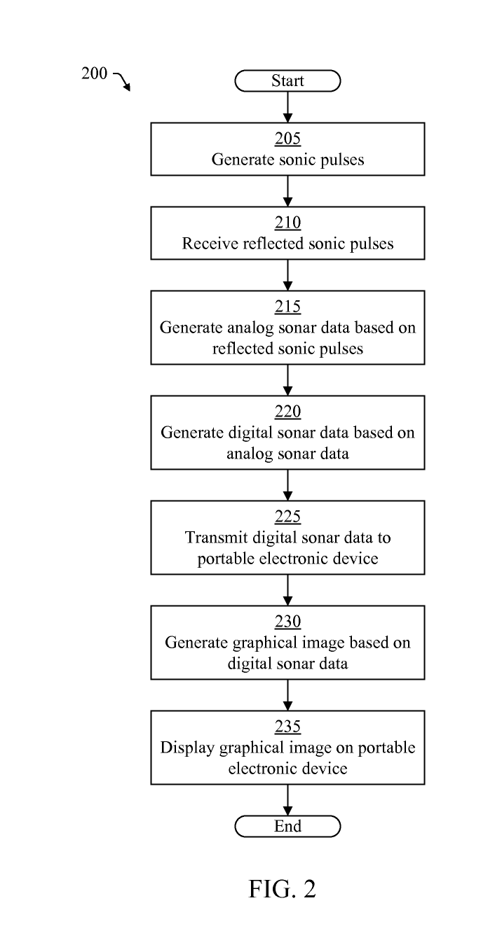

FIG. 2 is a flow chart of a method 200 of generating a sonar image, in accordance with an embodiment of the present invention. In step 205, sonic pulses are generated. In various embodiments, the sonic transducer 180 generates sonic pulses in response to control signals received from the transducer adapter 175 of the portable sonar data preprocessing device 110. The method 200 then proceeds to step 210.

In step 210, reflected sonic pulses are received. In various embodiments, the sonic transducer 180 receives reflected sonic pulses in response to the sonic pulses generated by the sonic transducer 180 and provides the reflected sonic pulses to the transducer adapter 175 of the portable sonar data preprocessing device 110. The method 200 then proceeds to step 215.

In step 215, analog sonar data is generated based on the reflected sonic pulses. In various embodiments, the transducer adapter 175 of the portable sonar data preprocessing device 110 generates the analog sonar data based on the reflected sonic pulses and provides the analog sonar data to the computing processor 115. For example, the transducer adapter 175 may generate a signal based on the reflected sonic pulses. In various embodiments, the transducer adapter 175 generates a signal based on the reflected sonic pulses and amplifies or filters the signal, or both, before providing the signal to the computing processor 115 of the portable sonar data preprocessing device 110. The method 200 then proceeds to step 220.

In step 220, digital sonar data is generated based on the analog sonar data. In various embodiments, the computing processor 115 generates the digital sonar data based on the analog sonar data generated by the transducer adapter 175. For example, the computing processor 115 may perform digital signal processing operations on the analog sonar data, such as fast Fourier transformations or inverse fast Fourier transformations. The method 200 then proceeds to step 225.

In step 225, the digital sonar data is transmitted to a portable electronic device. In various embodiments, the portable sonar data preprocessing device 110 transmits the digital sonar data to the portable electronic device 105. For example, the portable sonar data preprocessing device interface 130 may receive the digital sonar data from the computing processor 115 and transmit the digital sonar data to the portable electronic device interface 125 of the portable electronic device 105. The method 200 then proceeds to step 230.

In step 230, a graphical image is generated based on the digital sonar data. In various embodiments, the portable electronic device 105 generates the graphical image based on the digital sonar data generated by the portable sonar data preprocessing device 110. For example, the processing unit 145 of the portable electronic device 105 may generate the graphical image by executing the sonar imaging application 165. The method 200 then proceeds to step 235.

In step 235, the graphical image is displayed on the portable electronic device. In various embodiments, the portable electronic device 105 displays the graphical image on the display 120 of the portable electronic device 105. For example, the portable electronic device 105 may display the graphical image on the display 120 by using the graphical user interface 160. The method 200 then ends.

In various embodiments, the method 200 may include more or fewer than the steps 205-235 described above and illustrated in FIG. 2. In some embodiments, the steps 205-235 of the method 200 may be performed in a different order than that described above and illustrated in FIG. 2. In various embodiments, some of the steps 205-235 may be performed in parallel or substantially simultaneously.

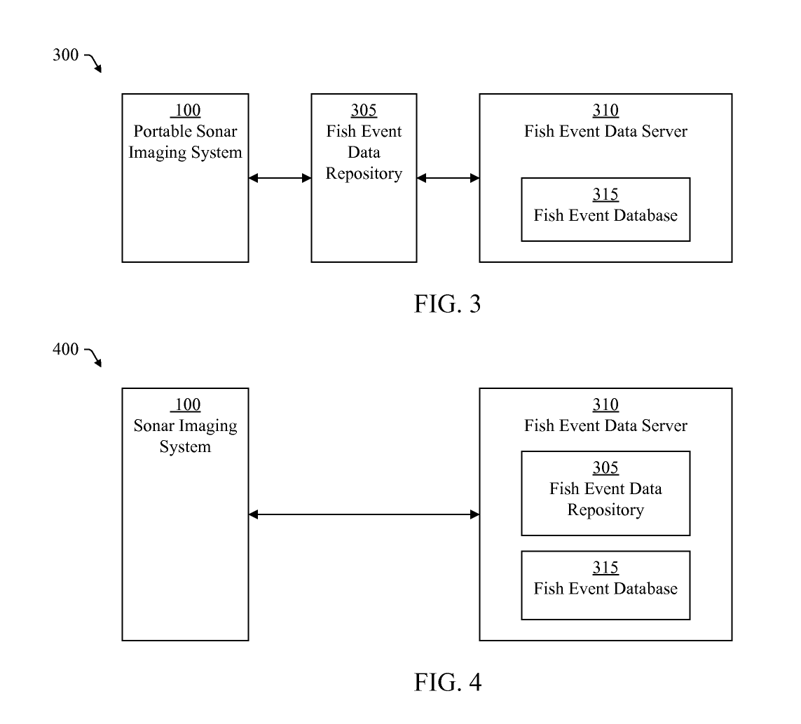

FIG. 3 illustrates a historical fish locator system 300, in accordance with one embodiment of the present invention. The historical fish locator system 300 includes the portable sonar imaging system 100, a fish event data repository 305, and a fish event data server 310. Each of the portable sonar imaging system 100 and the fish event data server 310 is coupled in communication with the fish event data repository 305. Moreover, the fish event data server 310 includes a fish event database 315.

In operation, the portable sonar imaging system 100 generates fish event data based on digital sonar data and provides the fish event data to the fish event data repository 305. In turn, the fish event data repository 305 stores the fish event data. In various embodiments, the fish event data indicates a geographical location of a fish as well as a date and time at which the fish was at the geographical location. In some embodiments, the fish event data further indicates environmental conditions of the fish at the date and time at which the fish was at the geographical location. In various embodiments, the environmental conditions include weather conditions or water conditions, or both. The weather conditions may include air temperature, barometric pressure, humidity, wind speed, wind direction, precipitation, cloud cover, or the like. The water conditions may include water temperature, water depth, wave conditions (e.g., swell height), or the like.

In various embodiments, the portable sonar imaging system 100 receives the geographic location data indicating the geographic location of the fish, receives time data indicating the time the fish was at the geographic location, and receives date data indicating the date the fish was at the geographic location. For example, the portable electronic device 105 may receive geographical location data, such as geographical location coordinates, from a global positioning system via a wireless communication link. As another example, the portable electronic device 105 may receive time data and date data from a cellular phone service provider. In other embodiments, the portable sonar imaging system 100 generates the geographic location data, the time data, or the date data, or some combination thereof. In some embodiments, the portable sonar imaging system 100 measures the depth of a fish in a body of water based on the digital sonar data and computes the location of the fish based on the depth measurement and geographical coordinates received by the portable electronic device 105. In some embodiments, the portable electronic device 105 may receive a topographical map of a lake via a wireless communication lake. For example, the topographical map of the lake may include depths of the lake (e.g., a contour map of the lake bottom) as well as the locations and depths of known objects (e.g., rocks) in the lake.

In some embodiments, the portable sonar imaging system 100 receives environmental data indicating the environmental conditions of the fish at the date and time indicated by the date data and time data. For example, the portable electronic device 105 may obtain weather information and water information from an Internet site through a wireless communication link to a cellular phone service provider. In other embodiments, the portable sonar imaging system 100 may generate some or all of the components of the environmental data. For example, the portable sonar imaging system 100 may include measurement devices for measuring the wind speed and wind direction or may obtain data from a user of the portable sonar imaging system 100 through the graphical user interface 160 of the portable electronic device 105.

The portable sonar imaging system 100 provides the fish event data to the fish event data repository 305. The fish event data repository 305 may be any system or device external to the portable sonar imaging system 100 for storing the fish event data. For example, the fish event data repository 305 may be a universal serial bus flash drive or a data storage device on a personal computer. In various embodiments, the fish event data repository 305 functions as a temporary storage location for the fish event data.

Although only one fish event data repository 305 is illustrated in FIG. 3, the historical fish locator system 300 may include any number of fish event data repositories 305 in other embodiments. For example, a fish event data repository 305 may be located at a specific fishing location for collecting fish event data recorded at the fishing location. In some embodiments, the fish event data repository 305 communicates with the portable electronic device 105 via a wireless communication link to automatically obtain the fish event data from the portable electronic device 105. For example, the portable electronic device 105 may detect the fish event data repository 305 and transmit the fish event data to the fish event data repository 305 through a wireless communication link. In other embodiments, the portable electronic device 105 transmits fish event data to the fish event data repository 305 through a cellular phone link.

The fish event data server 310 obtains fish event data from the fish event data repository 305 and updates the fish event database 315 with the fish event data. In this way, the fish event data server 310 creates a historical fish event database including the geographic location, time, date, and environmental conditions in which a fish is located in a body of water. Furthermore, the fish event data server 310 receives a fish event data query from a requestor, obtains fish event data from the fish event database 315 based on the fish event data query, and provide the fish event data to the requestor in response to the fish event data query. It is to be appreciated that a requestor may be any system or device that is capable of generating a fish event data query, such as a mobile phone, a tablet computer, a portable computer, a desktop computer, or a computing device connected to the Internet or a cellular service provider.

For example, the portable electronic device 105 in the portable sonar imaging system 100 may generate the fish event data query and provide the fish event data query to the fish event data server 310 and receive fish event data from the fish event data server 310 in response to the fish event data query. In turn, the portable electronic device 105 may generate a graphical image based on the fish event data and display the graphical image on the display 120 of the portable electronic device 105. In various embodiments, the graphical image may be a top-down image of a lake indicating where fish have been located historically at the date, time, and environmental conditions indicated in the fish event data.

In some embodiments, the top-down image includes statistical information indicating where fish have been located historically at the at the date, time, and environmental conditions. For example, the image of the lake may be divided into area sections each of which indicates a number of times a fish has been located historically in that section based on the date, time, and environmental conditions.

In some embodiments, the fish event data server 310 generates a graphical image based on a fish event data query received from the portable electronic device 105 of the portable sonar imaging system 100 and provides the graphical image to the portable electronic device 105. In turn, the portable electronic device 105 displays the graphic image on the display 120 of the portable electronic device 105. For example, the graphical image may include a topological map of a lake indicating where fish have been located historically at the at a given date, time, and environmental conditions. In some embodiments, the graphical image may further indicate the location of fish identified in the lake at the present time. For example, the location of fish identified in the lake at the present time may be superimposed on the topographical map of the lake.

FIG. 4. illustrates a historical fish locator system 400, in accordance with an embodiment of the present invention. The historical fish locator system 400 includes an embodiment of the portable sonar imaging system 100 and the fish event data server 310. The portable sonar imaging system 100 is coupled in communication with the fish event data server 310, which includes the fish event database 315. The historical fish locator system 400 of FIG. 4 functions in a similar manner to the historical fish locator system 300 of FIG. 3, except that the fish event data server 310 in the historical fish locator system 400 of FIG. 4 includes the fish event data repository 305. In this way, the historical fish locator system 400 of FIG. 4 need not have a fish event data repository 305 that is separate and distinct from the fish event server 310.

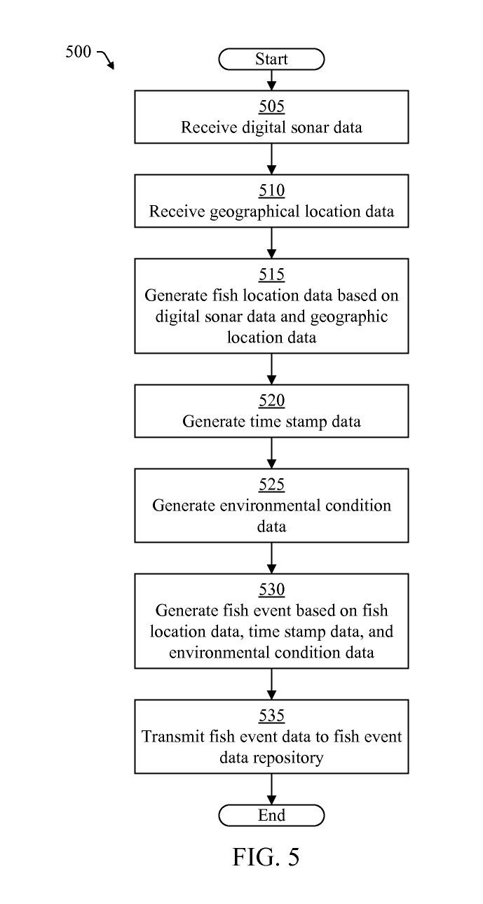

FIG. 5 illustrates a method 500 of generating fish event data for a fish event database, in accordance with an embodiment of the present invention.

In step 505, digital sonar data is received. In various embodiments, the portable electronic device 105 receives the digital sonar data, for example from the portable sonar data preprocessing device 110. The method 500 then proceeds to step 510.

In step 510, geographical location data is received. In various embodiments, the portable electronic device 105 receives the geographical location data, for example by receiving geographical coordinates from a global positioning system (GPS). The method 500 then proceeds to step 515.

In step 515, fish location data is generated based on digital sonar data and geographic location data. In various embodiments, the portable electronic device 105 generates the fish location data by identifying a fish based on the digital sonar data and using the geographic location data to determine a location of the identified fish. For example, the fish location data may include geographical coordinates or an offset from the geographical coordinates to account for distance between the receiver of the geographic location data (e.g., the portable electronic device 105) and the location of the identified fish. For example, the offset may include a distance between the portable electronic device 105 and the sonic transducer 180 or may include the depth of the fish in the body or water, or both. The method 500 then proceeds to step 520.

In step 520, a time stamp is generated. In various embodiments, the portable electronic device 105 generates the time stamp, for example based on date data in an internal calendar and time data of an internal clock. In other embodiments, the portable electronic device 105 obtains the date data and time data from one or more sources through a communication link such as the Internet or a cellular service provider network. For example, the portable electronic device 105 may obtain the time and date data from a server connected to the Internet. The method 500 then proceeds to step 525.

In step 525, environmental condition data is generated. In various embodiments, the portable electronic device 105 obtains the environmental data from one or more sources through a communication link such as the Internet or a cellular service provider network. For example, the portable electronic device 105 may obtain the environmental condition data from a server connected to the Internet. In other embodiments, the portable electronic device 105 generates one or more components of the environmental data, for example by measuring one or more environmental conditions. The method 500 then proceeds to step 530.

In step 530, fish event data is generated. In various embodiments, the portable electronic device 105 generates the fish event data based on the fish location data, the time stamp data, and the environmental condition data. For example, the fish event data may include the fish the location data, the time stamp data, and the environmental condition data. The method 500 then proceeds to step 535.

In step 535, the fish event data is transmitted to a fish event data repository. In various embodiments, the portable electronic device 105 transmits the fish event data to a fish event data repository 305. The method 500 then ends.

In various embodiments, the method 500 may include more or fewer than the steps 505-535 described above and illustrated in FIG. 5. In some embodiments, the steps 505-535 of the method 500 may be performed in a different order than that described above and illustrated in FIG. 5. In various embodiments, some of the steps 505-535 may be performed in parallel or substantially simultaneously.

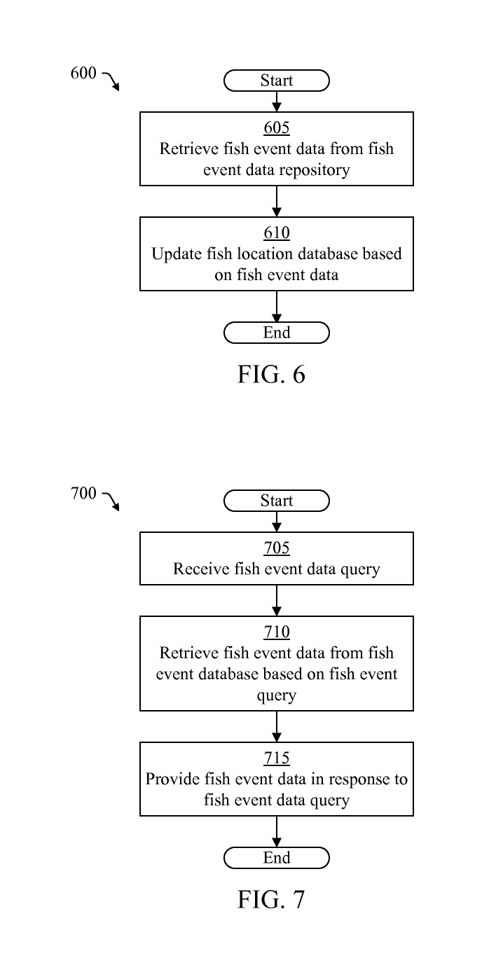

FIG. 6 illustrates a method 600 of updating a fish event database, in accordance with an embodiment of the present invention.

In step 605, fish event data is retrieved from a fish event data repository. In various embodiments, the fish event data server 310 retrieves the fish event data from one or more fish event data repositories 305. The method 600 then proceeds to step 610.

In step 610, a fish location database is updated based on fish event data. In various embodiments, the fish event data server 310 updates the fish event database 315 based on the fish event data. For example, the fish event data server 310 may perform one or more statistical operations on the fish event data and other fish event data already in the fish event database 315. The method 600 then ends.

FIG. 7 illustrates a method 700 of querying a fish event database, in accordance with an embodiment of the present invention.

In step 705, a fish event data query is received. In various embodiments, the fish event data server 310 receives the fish event data query from a source, for example from the portable electronic device 105. The method 700 then proceeds to step 710.

In step 710, fish event data is retrieved from a fish event database based on fish event query. In various embodiments, the fish event data server 310 retrieves fish event data from the fish event database 315 based on the fish event query. For example, the fish event data retrieved from the fish event database 315 may be a result of a statistical or mathematical function performed on a number of fish event data stored in the fish event database 315. The method 700 then proceeds to step 715.

In step 715, the fish event data retrieved from the fish event database is provided in response to fish event data query. In various embodiments, the fish event data server 310 provides the fish event data retrieved from the fish event database 315 to the source of the fish event data query previously received at the fish event data server 310. For example, the fish event data server 310 may provide the fish event data retrieved from the fish event database 315 to the portable electronic device 105. The method 700 then ends.

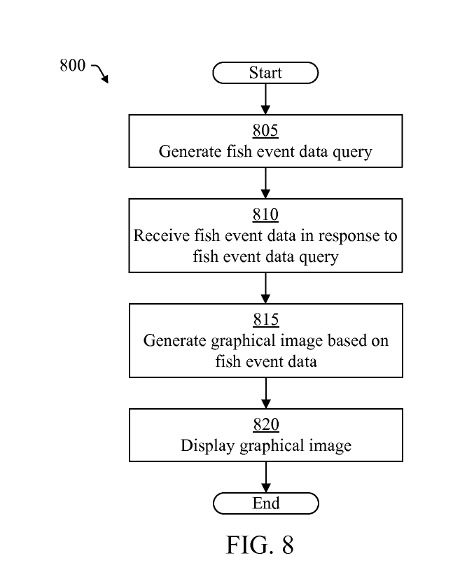

FIG. 8 illustrates a method 800 of displaying fish event data on a portable electronic device, in accordance with an embodiment of the present invention.

In step 805, a fish event data query is generated. In various embodiments, the portable electronic device 105 generates the fish event data query, for example based on user input to the portable electronic device 105. The method 800 then proceeds to step 810.

In step 810, fish event data is received in response to fish event data query. In various embodiments, the portable electronic device 105 receives the fish event data from the fish event database 315. For example, the portable electronic device 105 may obtain the fish event data from the fish event data server 310 in response to the fish event data query. The method 800 then proceeds to step 815.

In step 815, a graphical image is generated based on fish event data. In various embodiments, the portable electronic device 105 generates the graphical image based on the fish event data received in response to the fish event data query. For example, the graphical image may depict a body of water, such as a lake, river, or ocean, and indicate historical information of fish locations in the body of water. The method 800 then proceeds to step 820.

In step 820, the graphical image is displayed. In various embodiments, the portable electronic device 105 displays the graphical image on the display 120 of the portable electronic device 105. In some embodiments, a user may provide user input to the portable electronic device 105 to modify the graphical image displayed on the display 120 of the portable electronic device 105. For example, a user could push a button, scroll on a touch pad, or make a gesture for zooming in or zooming out on a portion of the graphical image. In some embodiments, the graphical image includes a depth indicator for a lure cast into the body of water and includes a depth indicator for a fish located in the body of a water. In this way, a fisherman can adjust the depth of the lure to the depth of the fish. The method 800 then ends.

Although the invention has been described with reference to particular embodiments thereof, it will be apparent to one of ordinary skill in the art that modifications to the described embodiment may be made without departing from the spirit of the invention. Accordingly, the scope of the invention will be defined by the attached claims not by the above detailed description.

What is claimed is:

1. A portable sonar data preprocessing device, comprising:
a transducer adapter configured to provide control signals to a sonic transducer for generating sonic pulses, receive reflected sonic pulses from the sonic transducer in response to providing the control signals to the sonic transducer, and generate analog sonar data based on the reflected sonic pulses;
a computing processor coupled to the transducer adapter and configured to generate digital sonar data based on the analog sonar data; and
a portable sonar data preprocessing device interface coupled to the computing processor and configured to provide the digital sonar data to a portable electronic device for generating a graphical image based on the digital sonar data.

2. A method of generating a sonar image, the method comprising:
generating sonic pulses;
receiving reflected sonic pulses;
generating analog sonar data based on the reflected sonic pulses;
generating digital sonar data based on the analog sonar data;
transmitting the digital sonar data to a portable electronic device;
generating a graphical image based on the digital sonar data; and
displaying the graphical image on the portable electronic device.

3. A historical fish locator system, comprising:
a portable sonar imaging system configured to generate fish event data;
a fish event data repository configured to store the fish event data in a fish event database; and
a fish event data server configured to update the fish event database based on the fish event data.

4. A method of generating fish event data for a fish event data repository, the method comprising:
receiving digital sonar data;
receiving geographical location data;
generating fish location data based on the digital sonar data and the geographical location data;
generating a time stamp;
generating environmental condition data;
generating fish event data based on the fish location data, the time stamp, and the environmental condition data; and
transmitting the fish event data to a fish event data repository.

5. A method of updating a fish event database, the method comprising:
receiving fish event data from a fish event repository; and
updating a fish event database based on the fish event data.

6. A method of querying a fish event database, the method comprising:
receiving a fish event data query;
retrieving fish event data from a fish event database based on the fish event data query; and
providing the fish event data in response to the fish event data query.

7. A method of displaying fish event data, the method comprising:
generating a fish event data query;
receiving fish event data in response to the fish event data query;
generating a graphical image based on the fish event data; and
displaying the graphical image.
